(19) United States
(12) Patent Application Publication
(10) Pub. No.: US 2016/0067851 A1
(43) Pub. Date: Mar. 10, 2016

(54) VEHICLE GAS CAP GRIP

(71) Applicant: Pamela Grace Beth Oakes, Fort Myers, FL (US)

(72) Inventor: Pamela Grace Beth Oakes, Fort Myers, FL (US)

(21) Appl. No.: 14/823,530

(22) Filed: Aug. 11, 2015

Related U.S. Application Data
(60) Provisional application No. 62/046,261, filed on Sep. 5, 2014.

(51) Int. Cl. B25B 27/00; B25B 13/48; B60K 15/04

(52) U.S. Cl. CPC B25B 27/0042; B60K 15/0406; B25B 13/48; B60K 2015/0515

(57) ABSTRACT

A gas cap grip is provided. The gas cap grip includes a body having a top end and a bottom end opposite the top end. A first slot is formed in between a first protrusion and a second protrusion extending from the bottom end. The first slot is sized to snugly receive a gripping portion extending from a gas cap of a vehicle.

### CROSS-REFERENCE TO RELATED APPLICATION

This application claims the benefit of priority of U.S. provisional application No. 62/046,261, filed Sep. 5, 2014, the contents of which are herein incorporated by reference.

### BACKGROUND OF THE INVENTION

The present invention relates to gas caps and, more particularly, to a vehicle gas cap grip.

A vehicle gas cap covers the gas tank of an automobile. The vehicle gas cap may be difficult to loosen and tighten for physically impaired drivers. A gas cap that is not properly tightened may cause emission issues and lower miles per gallon for the vehicle.

As can be seen, there is a need for a device that aids in tightening and loosening the gas cap.

### SUMMARY OF THE INVENTION

In one aspect of the present invention, a gas cap grip comprises: a body having a top end and a bottom end opposite the top end, wherein a first slot is formed in between a first protrusion and a second protrusion extending from the bottom end, wherein the first slot is sized to snuggly receive a gripping portion extending from a gas cap of a vehicle.

In another aspect of the present invention, a method of unscrewing a gas cap comprises: providing a gas cap grip comprising a body having a top end and a bottom end, wherein a slot is formed in between a first protrusion and a second protrusion extending from the bottom end; placing the gas cap gripper onto a gas cap such that a gripping portion of the gas cap is disposed within the first slot; and rotating the gas cap grip, and thereby unscrewing the gas cap.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a section view of the present invention taken from 3-3 in FIG. 1;

FIG. 4 is a front view of an embodiment of the present invention;

FIG. 5 is a front view of an embodiment of the present invention;

FIG. 6 is a bottom view of an embodiment of the present invention; and

FIG. 7 is a side view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include a block with a slot for a gas cap handle to fit within. The present invention provides a lager handle for individuals unable to maneuver the regular cap size. In certain embodiments, the block may be 1 inch×2 inches×2 inches. A first slot may be cut ¾ inches into one side and approximately ⅓ of inch deep. A second slot may be cut 1 inch wide and ⅞ of an inch deep. However, the block may be any appropriate size. The present invention is cost effective, easy to use, and compact. The present invention may be wood, plastic, metal or other appropriate material.

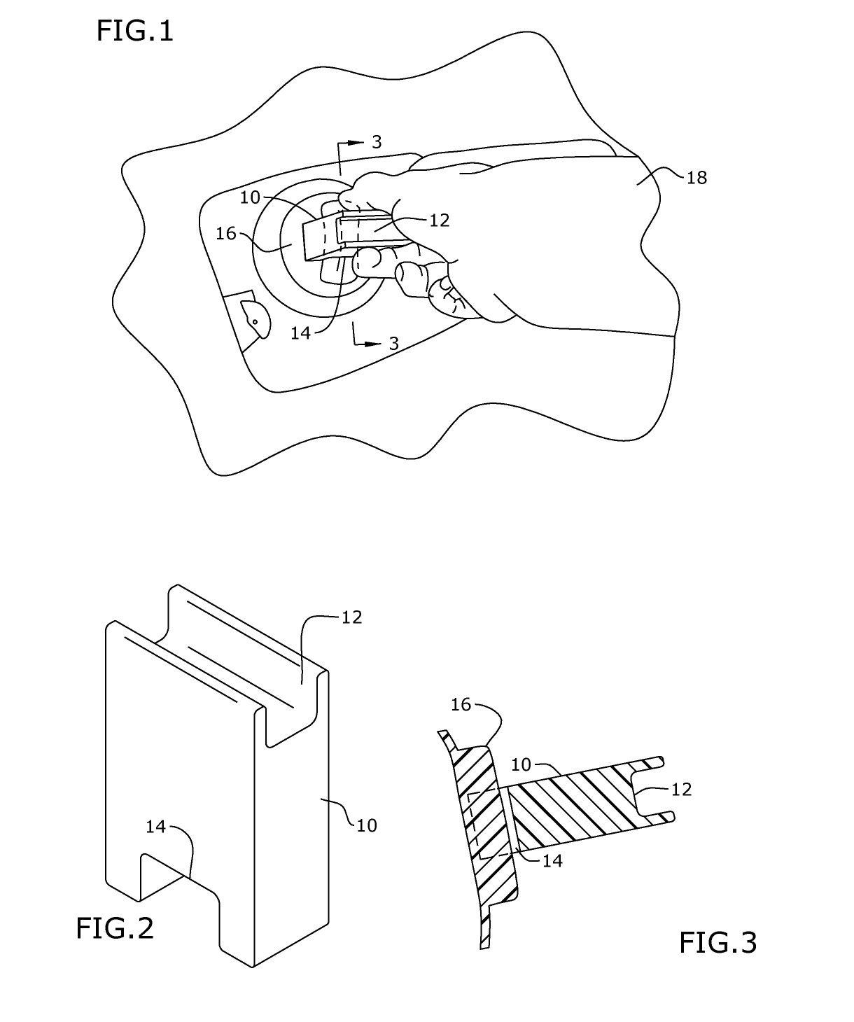

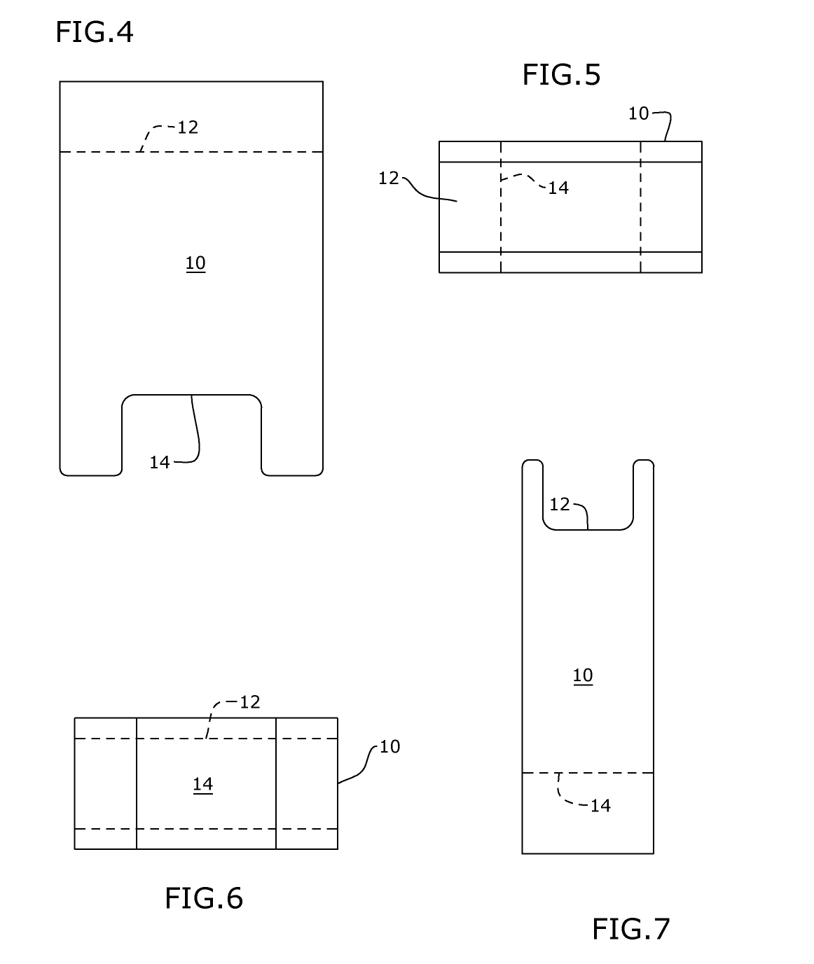

Referring to FIGS. 1 through 7, the present invention includes a gas cap grip. The gas cap grip includes a body 10 having a top end and a bottom end opposite the top end. A first slot 12 is formed in between a first protrusion and a second protrusion extending from the bottom end. The first slot is sized to snugly receive a gripping portion 20 extending from a gas cap 16 of a vehicle.

In certain embodiments, a second slot 14 is formed in between a first protrusion and a second protrusion extending from the top end. The second slot 14 is sized to receive a different sized gripping portion extending from a gas cap of a different vehicle. Therefore, the width of the second slot 14 is different than the width of the first slot 12. This allows the gas cap gripper of the present invention to be used with different vehicles.

The first protrusion and the second protrusion forming the first slot 12 may be substantially parallel with one another. Further, the first protrusion and the second protrusion of the second slot 14 may be substantially parallel with one another. In certain embodiments, the first slot 12 and the second slot 14 are substantially perpendicular relative to one another.

The body 10 of the present invention may be a large block shape so that physically impaired drivers may easily grip the gas cap handle. In certain embodiments, the block shape may be a rectangular cuboid. The rectangular cuboid may include the top end, the bottom end, a front surface, a rear surface, a first side surface, and a second side surface. The first slot 12 may run from the first side surface to the second side surface and the second slot 14 may run from the front surface to the rear surface.

A method of using the present invention may include the following. The user 18 may hold the body 10 in their hand with the slot pointed towards the gas cap handle. The gas cap handle is the gripping portion 20 of the gas cap 16. The user 18 may place the first or second slot 12, 14 over the gripping portion 20 of the gas cap 16 and turn to the left to unscrew the gas cap 16. To place the gas cap 16 back onto the vehicle, the user may place the first or second slot 12, 14 over the gripping portion 20 and then turn to the right to tighten the gas cap 16. The user 18 may remove the block and store the block in a glove box or other compartment within the vehicle.

It should be understood, of course, that the foregoing relates to exemplary embodiments of the invention and that modifications may be made without departing from the spirit and scope of the invention as set forth in the following claims.

What is claimed is:

1. A gas cap grip comprising:
a body having a top end and a bottom end opposite the top end, wherein a first slot is formed in between a first protrusion and a second protrusion extending from the bottom end, wherein the first slot is sized to snuggly receive a gripping portion extending from a gas cap of a vehicle.

2. The gas cap grip of claim 1, wherein a second slot is formed in between a first protrusion and a second protrusion extending from the top end, wherein the second slot is sized to receive a different sized gripping portion extending from a gas cap of a different vehicle.

3. The gas cap grip of claim 2, wherein the first slot and the second slot are substantially perpendicular relative to one another.

4. The gas cap grip of claim 1, wherein the body is a block shape.

5. The gas cap grip of claim 4, wherein the block shape is a rectangular cuboid.

6. A method of unscrewing a gas cap comprising:
providing a gas cap grip comprising a body having a top end and a bottom end, wherein a slot is formed in between a first protrusion and a second protrusion extending from the bottom end;
placing the gas cap grip onto a gas cap such that a gripping portion of the gas cap is disposed within the first slot; and
rotating the gas cap grip, and thereby unscrewing the gas cap.

7. The method of claim 6, wherein the body is a block shape.

8. The method of claim 7, wherein the block shape is a rectangular cuboid.
